(19) United States
(12) Patent Application Publication
(10) Pub. No.: US 2022/0325766 A1
(43) Pub. Date: Oct. 13, 2022

(54) Measuring Device for Detecting an Operating Parameter of an Agricultural PTO Drive Shaft

(71) Applicant: Off-Highway Powertrain Services Germany GmbH, Lotmar (DE)

(72) Inventors: Nolan House, Clarendon Hills, IL (US); Max Krüger, Lohmar (DE); Thomas Jung, Bonn (DE)

(21) Appl. No.: 17/715,419

(22) Filed: Apr. 7, 2022

(30) Foreign Application Priority Data
Apr. 7, 2021 (EP) 21167230.8

(51) Int. Cl. F16D 66/02; F16D 3/84

(52) U.S. Cl. CPC F16D 66/028; F16D 3/841; F16D 2300/18; F16D 2066/001

(57) ABSTRACT

The present invention relates to a measuring device with a magnetic field sensor for detecting at least one operating parameter of an agricultural joint shaft for torque transmission between a power take-off shaft of a towing vehicle and a transmission of an agricultural appliance, which includes at least one journal cross, to the opposing journals of which a shaft body is connected, and a protective tube rotatably accommodating the shaft body therein, wherein the magnetic field sensor is adapted to measure a magnetic field emanating from the bare shaft body of the joint shaft.

### CROSS-REFERENCE TO RELATED APPLICATION

This application claims priority to European Patent Application No. 21167230.8 filed Apr. 7, 2021, the disclosure of which is hereby incorporated by reference in its entirety.

### BACKGROUND OF THE INVENTION

### Field of the Invention

The present invention relates to a measuring device for detecting an operating parameter of an agricultural joint shaft.

### Description of Related Art

Agricultural joint shafts are used to transmit torque between a power take-off shaft of a towing vehicle and a transmission of an agricultural appliance and, to protect an operator, comprise a joint shaft protection with a protective tube made of plastic, which surrounds a shaft body of the joint shaft and is secured against rotation by a chain.

Such an agricultural joint shaft is known, for example, from EP 3 719 336 A1 or WO 2020/222210 A1.

The joint shaft known from WO 2020/222210 A1 comprises a measuring device for detecting an operating parameter of the joint shaft. The measuring device includes several sensors distributed over the joint shaft, the signals of which are transmitted by means of antennas from a secondary electronics unit attached to the shaft body to a main electronics unit attached to the protective tube. The measuring device can include a Hall sensor that registers a rotation of magnets attached to the shaft body of the joint shaft to detect a rotational speed.

WO 2020/222210 A1 offers room for improvement.

### SUMMARY OF THE INVENTION

The problem underlying the present invention is to provide a simpler measuring device for detecting an operating parameter of an agricultural joint shaft. In particular, the present invention in this context also focuses on reducing the installation effort required to attach the measuring device to the joint shaft and aims to enable simple retrofitting of a joint shaft with a measuring device.

In order to solve this problem, the present invention provides a measuring device for detecting at least one operating parameter of an agricultural joint shaft with the features of claim 1.

The agricultural joint shaft can be used for torque transmission between a power take-off shaft of a towing vehicle and a transmission of an agricultural appliance. It has at least one journal cross, to the opposite journal of which a shaft body is connected, and a protective tube rotatably accommodating the shaft body. The protective tube is usually made of ammonia-resistant plastic. The measuring device according to the invention includes a magnetic field sensor adapted to measure a magnetic field emanating from the bare shaft body of the joint shaft.

The shaft body of the agricultural joint shaft is usually adjustable in length and configured in the manner of a splined shaft or hub. The shaft body usually comprises an inner tube and an outer tube, wherein the inner tube is accommodated in the outer tube so as to be displaceable in the longitudinal direction. In order to prevent loss of torque transmission due to mutual twisting of the inner tube and outer tube, the cross-section of the inner tube and outer tube deviates from a circular shape. In this respect, the profile of the shaft body is not rotationally symmetrical in the narrower sense. Often, the inner tube and the outer tube have a so-called lemon profile or a so-called star profile. Due to the manufacturing process, the shaft body therefore has a certain magnetic alignment, so that a rotation of the shaft body leads to a change in the magnetic field emanating from the bare shaft body. As a rule, the bare shaft body is to be understood as the unfitted shaft body, which is composed of the bare inner tube and the bare outer tube, which are usually made of steel. In any case, the bare shaft body is usually free of additional magnetic components.

The measuring device according to the invention thus allows an operating parameter of an agricultural joint shaft to be detected in the simplest possible manner and with the fewest possible components to be attached to the joint shaft. The manufacturing costs and the installation effort are thus reduced.

According to a preferred further development of the present invention, the measuring device comprises a closed sensor housing which accommodates the magnetic field sensor and an energy source for the magnetic field sensor and is configured for non-rotatable attachment to an outer or an inner side of the protective tube. The sensor housing is preferably made of plastic, for example PE or ABS. It may be made of the same ammonia-resistant material as the protective tube. However, the protective tube and the sensor housing are usually separately manufactured components. The sensor housing usually completely encapsulates the magnetic field sensor and the energy source as well as any other sensors; i.e. it completely surrounds the magnetic field sensor and the energy source in all three spatial directions. As a result, the sensor housing offers reliable protection against external influences such as moisture, dirt and impacts caused, for example, by falling rocks. The energy source for the sensor(s) is preferably a battery. The sensor housing is in any case preferably free of a lead-through opening for power cables or other cables.

The sensor housing is preferably adapted for non-rotational attachment to an outer circumferential surface of the protective tube. However, it can also be configured for non-rotational attachment to an inner circumferential surface of the protective tube. It can also comprise two different contact surfaces, wherein one contact surface is adapted for non-rotational attachment to an outer circumferential surface of the protective tube and the other is adapted for non-rotational attachment to an inner circumferential surface of the protective tube. As a result, the measuring device can be easily mounted. Agricultural joint shafts without a measuring device can be easily retrofitted.

According to another preferred further development of the present invention, the sensor housing comprises a concave inner surface which can be applied to the protective tube and is formed from curved and/or straight surface sections. The directional indication “inner” and “outer” is used here and hereinafter with the axis of rotation of the joint shaft as the central reference point. In this respect, an inner surface of the sensor housing is to be understood as a surface facing the axis of rotation, whereas an outer surface of the sensor housing is to be understood as a surface facing away from the axis of rotation. The concave inner surface forms at least one surface section as a contact surface for contacting an outer periphery of the protective tube, which is substantially round. The inner surface is preferably shaped so that the sensor housing can be applied to protective tubes of different sizes, wherein, in a cross-sectional view, the smallest protective tube is usually applied to the center of the inner surface and the largest protective tube is applied to the outer edges of the inner surface. Usually, at least the central surface section of the inner surface is curved; i.e., it corresponds to an arc of a circle with a fixed radius of curvature in the cross-sectional view. The radius of curvature of other curved surface sections usually decreases the further laterally the surface section is arranged from the center. Analogously, the distance of straight surface sections to the center of curvature increases the further laterally the surface section is arranged from the center. A straight surface section corresponds to a straight line in the cross-sectional view.

Due to the described configuration of the inner surface, the sensor housing can fit protective tubes of different sizes. The geometry of the sensor housing is preferably universally compatible with all protective tubes commonly available on the market.

Further preferably, the sensor housing comprises, opposite the inner surface, a convex outer surface formed of curved and/or straight surface sections. Preferably, the outer surface is shaped such that a protective funnel for a joint formed with the journal cross can be slid over the protective housing when the inner surface of the sensor housing abuts the outer periphery of the protective tube. This allows the sensor housing to be attached to the joint shaft in proximity to the protective funnel without interfering with the lubrication of the joint. Additionally or alternatively, the outer surface may be formed to abut an inner circumference of the protective tube.

According to another preferred further development of the present invention, the sensor housing is provided with a positioning journal on a side forming a contact surface for contact with the protective tube. The contact surface is formed by the inner surface of the sensor housing if the sensor housing is attached to the outside of the protective tube, and by the outer surface of the sensor housing if the sensor housing is attached to the inside of the protective tube. The positioning journal can be provided in the center of the inner surface or near an edge of the inner surface. It can engage in a bore in the protective tube. Preferably, the positioning journal has a shoe configured to butt against an inner surface of the protective tube and/or is installed in a bore in the protective tube with positive locking. More than one positioning journal can be provided, preferably at locations corresponding to the location of screw tabs formed by the sensor housing, wherein the positioning journals can be designed to cooperate with the two screw tabs by, for example, providing a female thread for the male thread of a screw. As a result, the positioning journal secures a position of the sensor housing on the protective tube. The positioning is usually fixed by fastening means. For this purpose, the sensor housing can form the aforesaid screw tabs designed to cooperate with a positioning journal or, for example, have a flange with a fastening hole for a screw to be screwed into the protective tube and/or be connected to the protective tube by gluing and/or by means of a cable tie. It is understood that the fastening of the sensor housing to the protective tube can also be done without the presence of a positioning journal on the sensor housing. The magnetic field sensor can be integrated into the positioning journal to increase the signal strength.

According to another preferred further development of the present invention, in addition to the magnetic field sensor, at least one further sensor, for example an acceleration sensor and/or a temperature sensor, is provided in the sensor housing.

According to another preferred further embodiment of the present invention, a processor is provided in the sensor housing which processes a sensor signal from one or more of the sensors to determine at least one operating parameter of the joint shaft, in particular the rotational speed. Preferably, the processor is arranged to determine the rotational speed from the magnetic field sensor signals. In this preferred further development, the detection of the sensor signals and the processing of the sensor signals take place in the same structural unit.

According to another preferred further development of the present invention, the measuring device has an operating hours counter for the joint shaft, which is incremented as a function of the at least one operating parameter. The operating hours can be derived, for example, from the duration of a rotation of the joint shaft, wherein the rotation is detected with the magnetic field sensor. A measured acceleration and/or a temperature change can also be used as an indication of a rotation of the joint shaft and thus of the operating hours. The temperature measurement is usually also used to detect a malfunction or high wear.

Agricultural joint shafts are highly stressed components that must be lubricated at regular distances to ensure maximum service life. The optimum interval for lubricating the bearing points of a joint shaft joint depends on the bearing used, the loads, the ambient conditions and the intended use of the joint shaft. The joint shaft manufacturer determines an optimum lubrication interval for each application. The operator is instructed to lubricate at the rhythm of the optimum lubrication interval. In this respect, the operating hours counter for the joint shaft makes it easier for the operator to comply with this regulation.

According to another preferred further development of the present invention, the processor is adapted to evaluate a sensor signal for detecting a movement of a working machine connected to the joint shaft and to increment an operating hours counter for the working machine as a function of a duration of the detected movement. The movement of the working machine is usually detected by the acceleration sensor. The acceleration sensor usually detects a vibration caused by an operation of the working machine. The operating hours counter for the working machine facilitates the accounting of the actual work performance for a contract operation.

According to another preferred further development of the present invention, a transmitting device connected data-wise to the processor is provided in the sensor housing, which transmits the determined operating parameter(s) and/or a counter reading of the operating hour meter(s) wirelessly to a receiver adapted for data processing. The receiver may, for example, be integrated into a console of the towing vehicle or be a mobile terminal of the driver of the towing vehicle or a mobile terminal of the operator or a maintenance person. Usually, the mobile terminal, e.g. a smartphone or a tablet, has a display for showing the operating parameters and/or the operating hours.

Further preferably, the measuring device comprises means for outputting a warning or maintenance signal triggered by reaching a predetermined counter reading of an operating hours counter. For example, a speaker may be provided in the sensor housing to generate a loud beep sound when the predetermined counter reading is reached. Additionally or alternatively, an externally visible illuminant, such as an LED, may be integrated into a wall of the sensor housing to illuminate when the predetermined counter reading is reached. The receiver may also have means for outputting a warning signal. The display and/or the speaker of the mobile terminal can be used for this purpose, for example. The output of warning or maintenance signals makes it easier to monitor the actual operating hours of the components and to perform maintenance at the right time. Critical situations caused by exceeding the specifications can be monitored and a serious component failure prevented by timely alerting. If the appropriate maintenance is carried out, the alarm and the triggering counter can be reset by activating a trigger. The trigger can be activated, for example, by pressing a pushbutton on the sensor housing or by wireless data communication, e.g. via NFC or radio.

According to another preferred further embodiment of the present invention, the measuring device has a stand-by mode and an operating mode implemented as control logic on the processor, wherein the processor is arranged to switch from the stand-by mode to the operating mode in response to a sensor signal from one of the sensors. In the stand-by mode, the measurement device has minimal power consumption. This extends the service life of the battery. The processor is essentially off in the stand-by mode. It switches on when one of the sensors generates a signal that exceeds a predefined threshold. The threshold is usually determined in advance by determining a noise and/or other disturbance variables and stored on the processor. The activity of the processor in stand-by mode is preferably limited to a background activity, namely to compare a received sensor signal with the threshold. Usually, the processor also receives sensor signals less frequently in stand-by mode by polling them only at discrete, preferably constant, time intervals. By switching on the processor, the measuring device is switched from stand-by mode to operating mode, in which the sensor signals are continuously sent to the processor and evaluated by it to detect operation of the joint shaft and/or the working appliance in order to increment the operating hours counter(s). In stand-by mode, it is sufficient if only one of the sensors, for example the acceleration sensor, is active. The acceleration sensor detects acceleration signals generated by a movement of the joint shaft and/or the working appliance. If active operation of the joint shaft or the working appliance is no longer detected, the measuring device switches back to stand-by mode.

Switching from the stand-by mode to the operating mode may in itself be essential to the invention. That is, the features of the generic term of claim 1, the features of claim 7, and the features of claim 12 may define a subject matter that may be essential to the invention in and of itself. This subject matter may also be essential to the invention with a sensor for sensing an operating parameter other than a magnetic field sensor.

Preferably, a data memory associated with the processor is arranged in the sensor housing, which can store the operating parameters and/or the operating hours. In the operating mode, the data memory can be read out periodically and the data sent from the transmitter to the receiver. The period duration until the next readout can be 10 seconds, for example.

In a parallel aspect, the present invention discloses an agricultural joint shaft for torque transmission between a power take-off shaft of a towing vehicle and a transmission of an agricultural appliance, which joint shaft comprises at least one journal cross, to the opposing journals of which a shaft body is connected, a protective tube rotatably accommodating the shaft body therein, and a measuring device according to the invention, which is non-rotatably attached to the protective tube. The protective tube is generally configured as introductorily described, in particular made of an ammonia-resistant plastic and secured against rotation by a chain. The protective tube is also usually adjustable in length and is usually composed of an inner tube and an outer tube, wherein the inner tube is accommodated in the outer tube so as to be displaceable in the longitudinal direction and the inner tube and the outer tube are secured against mutual rotation due to their cross-sectional profile or other securing means. The sensor housing is preferably attached to an outer circumference of the protective tube. The type of fastening can be material-, form- and/or force-locking. For example, the sensor housing can be screwed to the protective tube, glued to the protective tube, connected to the protective tube by means of a cable tie, an O-ring or by a press fit.

Further preferably, the sensor housing is dimensioned and/or attached to the protective tube such that a protective funnel for a joint of the joint shaft formed with the journal cross can be slipped over the sensor housing onto the protective tube. In this way, the sensor housing can be attached to the joint shaft in the vicinity of the protective funnel without interfering with the lubrication of the joint, in which the protective funnel is usually slid over the shaft.

In some areas of the world, it is not required by law or by a standard that the protective tube must be secured against rotation by a chain or the like. But even where it is required that the protective tube must be secured against rotation, an operator may omit or forget to do so. Therefore, it is preferable that the measuring device of an embodiment is configured to detect rotation of the protective tube. More preferably, the measuring device can be configured to initiate at least one of a warning signal and an alarm in response to the detection of a rotation of the protective tube. A warning signal or an alarm can remind the operator to secure the protective tube against rotation. In one embodiment of the present invention, the measuring device can be designed to store on a memory that a warning signal or an alarm was initiated.

Typically, the inner tube and the outer tube of the shaft body are each connected at their free end with a joint. Each of these joints has a journal cross with two opposing pairs of journals, wherein the inner tube or the outer tube of the shaft body is connected by a fork to one of the two pairs. The other pair of journals is connected by a fork to a shaft body stub which can be slid onto a power take-off shaft stub of a power take-off shaft, wherein the connection between the joint shaft stub and the power take-off shaft stub is secured by a releasable fastener which typically cooperates with a circumferential groove formed on the power take-off shaft stub.

In one method aspect, the present invention discloses a method for detecting an operation and/or an operating rotational speed of an agricultural joint shaft by measuring a magnetic field change of a magnetic field emanating from a bare shaft body of the joint shaft. As introductorily explained, the method according to the invention makes use of the fact that the shaft body has a certain magnetic alignment due to its manufacture and a rotation of the shaft body leads to a change in the magnetic field emanating from the bare shaft body, which is measured by a magnetic field sensor provided stationary relative to the shaft body and not rotating with the shaft body. The magnetic field sensor is preferably attached to an outer circumference of the protective tube. The signals of the magnetic field sensor are evaluated by a processor which is able to distinguish the signals generated by an operation of the joint shaft from other disturbance variables or to separate them from each other. For example, all signals corresponding to a rotation of at least or more than rotations per minute can be evaluated as operation of the joint shaft. Disturbance variables can be, for example, vibrations and other movements during a transport run without actual operation of the joint shaft. The disturbance variables are filtered out by the processor using mathematical signal processing methods. The operating states of the joint shaft recorded in this way are stored in a data memory assigned to the processor. Additionally or alternatively, the operating hours can be derived from the operating states and stored. The stored data is usually sent wirelessly to a receiver remote from the joint shaft, for example to a usually mobile terminal of the operator of the joint shaft or the driver of the towing vehicle. The wireless communication interface for transmitting the data can use NFC or radio, exemplary mentioned here are Bluetooth, Wifi or similar transmission protocols.

In a parallel method aspect, the present invention provides a method for detecting an operation of a working machine coupled to a utility vehicle and connected to the utility vehicle by an agricultural joint shaft by evaluating a sensor signal from the measuring device. In this method, an acceleration sensor is generally mounted on the protective tube to detect a movement or a vibration caused by an operation of the working machine. The signals from the acceleration sensor are evaluated by the processor unit, which filters out any noise or interference signals from the measured signals.

According to a parallel aspect of the present invention, the measuring device can be adapted to detect the presence of a mounted machine on the towing vehicle by one or more of the sensors and to store the presence or the time and/or duration of the presence on the data memory. Reading out the data memory thus provides a means of monitoring the duration of use of the mounted machine. The data stored on the data memory can preferably be read into an accounting software.

### BRIEF DESCRIPTION OF THE DRAWINGS

Further details and advantages of the present invention will be apparent from the following description of embodiments in conjunction with the drawing. Therein:

FIG. 1 shows a side view of an agricultural joint shaft looking inside the protective tube by omitting the protective tube in the center of the Figure,

FIG. 2 shows a cross-sectional view of a joint shaft according to a first embodiment,

FIG. 3 shows a cross-sectional view of a joint shaft according to a second embodiment,

FIG. 4A shows a section of a perspective side view of the joint shaft according to the first embodiment,

FIG. 4B shows an enlarged view of detail I of FIG. 2,

FIG. 5 shows a diagram with measured acceleration and measured magnetic field over time and

FIG. 6 shows a diagram with process flow for operation recognition.

### DESCRIPTION OF THE INVENTION

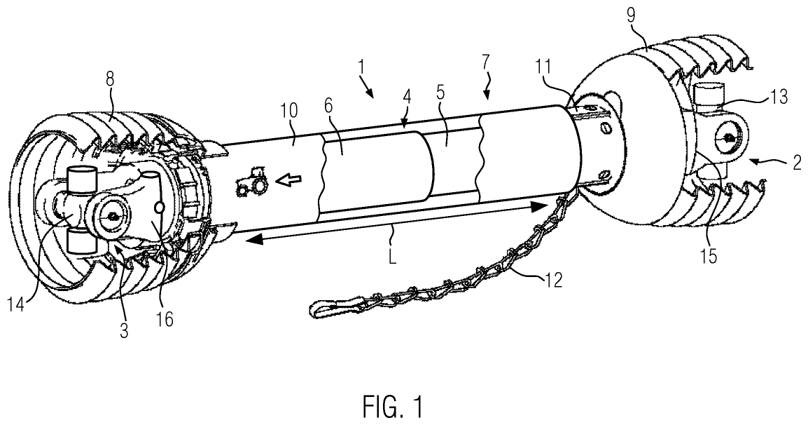

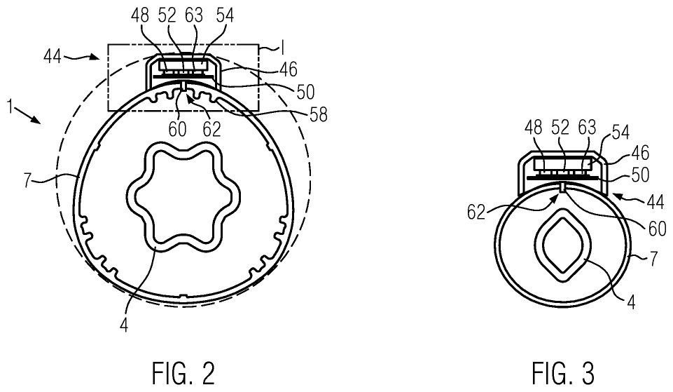

FIG. 1 shows a perspective side view of an agricultural joint shaft 1 with a first joint 2 and a second joint 3, which are connected to each other via a shaft body 4 that is adjustable in length. The shaft body 4 is made of steel and comprises an inner tube 5 connected to the first joint 2 and an outer tube 6 connected to the second joint 3. The inner tube 5 is accommodated in the outer tube 6 so as to be displaceable in the longitudinal direction L of the joint shaft 1. In order to prevent a loss of torque transmission due to mutual twisting of the inner tube 5 and the outer tube 6, the inner tube 5 and the outer tube 6 have a cross-section deviating from a circular shape. In this case, the inner tube 5 and the outer tube 6 have a so-called star profile (see FIG. 2) or a lemon profile (see FIG. 3).

In order to protect an operator, the agricultural joint shaft 1 comprises a joint shaft protection, which includes a protective tube 7 surrounding the shaft body 4 and two protective funnels 8, 9 covering the joints 2, 3. The joint shaft protection is generally made of ammonia-resistant plastic. The protective tube 7 consists of an outer protective tube 10 and an inner protective tube 11, wherein the inner protective tube 11 is accommodated in the outer protective tube 10 so as to be displaceable in the longitudinal direction L. The inner protective tube 11 is mounted in the outer protective tube 10. In order to prevent the joint shaft protection from rotating, a chain 12 is provided on the joint shaft protection, which can be attached to a towing vehicle or working appliance.

The joints 2, 3 are each configured as universal joints with a journal cross 13, 14, to the opposite journals of which a fork 15, 16 is connected. The opposing journals of the journal cross 13, 14, which are free in FIG. 1, are generally connected via a further (not shown) fork to a shaft body stub, which can be pushed onto a power take-off shaft stub of a power take-off shaft or a drive journal of a transmission of a driven machine for torque transmission.

According to the present invention, a measuring device is attached to the agricultural joint shaft 1. The shaft body may have a star profile or a lemon profile. It goes without saying that the measuring device according to the present invention can also be attached to other agricultural joint shafts and that the shaft body profiles mentioned are only given here as examples.

FIG. 2 illustrates a cross-sectional view of the joint shaft 1, in which a measuring device 44 for detecting at least one operating parameter of the agricultural joint shaft 1 is mounted on the protective tube 7 of the agricultural joint shaft 1. The measuring device 44 comprises a closed sensor housing 46, which encloses a magnetic field sensor 48, which is provided on a circuit board 50 with a processor 52. The circuit board 50 is supplied with electrical power from a battery 54 as a power source, wherein the battery 54 is also arranged in the closed sensor housing 46. The closed sensor housing 46 is made of plastic and encapsulates the components accommodated therein in all three spatial directions. The magnetic field sensor 48 is adapted to measure a magnetic field emanating from the bare shaft body 4 of the joint shaft 1.

The shaft body 4 of the joint shaft 1 has a star profile in cross-section, whereas the cross-section of the protective tube 7 is egg-shaped. The protective tube 7 has inwardly directed projections 58 that prevent twisting between the inner protective tube 5 and the outer protective tube 6. The sensor housing 46 has a positioning journal 60 centrally located on its underside, which engages a bore 62 on the protective tube 7 to secure the position of the sensor housing 46 on the outer circumference of the protective tube 7. The bore 62 is provided in the circumferential direction at the point where the egg-shaped cross-section has its apex.

The circle formed by dashed lines in FIG. 2 represents an installation space limit for the measuring device 44, which is derived from the inner diameter of the protective funnels 8, 9. The sensor housing 46 fits between the outer circumference of the protective tube 7 at its tip and the installation space limit. This allows the sensing device 44 to be located near either of the protective funnels 8, 9 without interfering with lubrication of the joints 2, 3. In the event of lubrication, the protective funnels 8, 9 can be pushed across the sensor housing 46 towards the axial center of the protective tube 7. The protective funnels 8, 9 may have a recess or flap at their narrower end through which the sensor housing 46 fits when the protective funnel 8, 9 is slid over it.

The processor 52 evaluates the signals from the magnetic field sensor 48 to determine at least one operating parameter of the joint shaft 1. The operating parameters include the detection of a rotation of the joint shaft 1 per se and, in particular, the rotational speed of the joint shaft 1. The rotational speed is generally determined by the joint shaft 1 generating periodic maxima and minima in the measured values of the magnetic field sensor 48 during a rotation. Since the geometry of the shaft body profile is known, the rotational speed can be determined from the period duration. An acceleration sensor 63 is also provided in the sensor housing 46. Its signals are used to determine a movement of an appliance connected to the towing vehicle. Noise and interference signals from the sensors are filtered out by logic implemented on the processor 52.

Further, a data memory (not shown) associated with the processor 52 for storing operating parameters and a transmitting device (not shown) for wirelessly transmitting data stored on the data memory are provided in the sensor housing 46. From the signals of the magnetic field sensor 48 and the acceleration sensor 63, the processor derives the operating hours of the joint shaft and the operating hours of the working appliance, which are recorded with operating hour counters implemented in the logic of the processor 52. The operating hours are stored and sent as operating parameters.

The logic of the processor 52 includes the previously described control for switching between the stand-by mode and the operating mode. A signal from the acceleration sensor 63 is used as a triggering signal for a switchover if it exceeds a predetermined threshold. The sensor housing 46 further has an externally visible LED (not shown) that lights up red as a warning signal as soon as one of the operating hour counters exceeds a predetermined threshold value.

FIG. 3 illustrates a second embodiment in which the previously described measuring device 44 is mounted on the protective tube 7 of the agricultural joint shaft 1 for detecting at least one operating parameter of the agricultural joint shaft 1, and the shaft body 4 of the joint shaft 1 has a lemon profile in cross-section, whereas the cross-section of the protective tube 7 is round. The extension of the protective tube 7 in the radial direction is smaller than that of the protective tube 7 of the first embodiment. Therefore, the contact surface at which the sensor housing 46 abuts the protective tube is further in the center of the sensor housing 46 in the cross-sectional view of the second embodiment than in the first embodiment.

The measuring device 44 is the same in both embodiments. The sensor housing 46 is configured in such a way that it can be applied to protective tubes of different sizes.

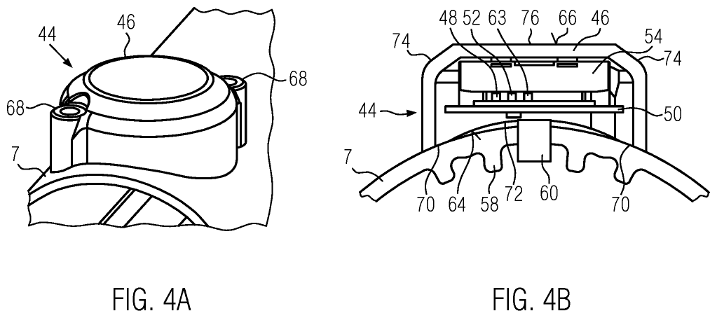

FIG. 4A shows a magnified view of the sensing device 44, and FIG. 4B illustrates that the sensor housing 46 has a convex inner surface 64 engageable with the outer periphery of the protective tube 7 and a concave outer surface 66 opposite the inner surface 64. Shown also are two screw tabs 68 projecting laterally from the sensor housing 46 and having a mounting hole for a screw to secure the sensor housing 46 to the protective tube 7.

FIG. 4B shows detail I of FIG. 2 in enlarged view, and it can be seen that the concave inner surface 64 is composed of two lateral straight surface sections 70 that would intersect if they were thought to be elongated, and a curved central surface section 72 that connects the two lateral straight surface sections 70. The concave outer surface 66 also includes two straight surface sections 74 that would intersect if they were thought to be elongated. However, the surface section connecting the straight surface sections 74 of the outer surface 66 is also formed as a straight surface section 76.

FIG. 4A shows the measuring device 44 in a perspective side view, illustrating that the sensor housing 46 is substantially round in a lateral circumferential direction. The circuit board 50 and the battery 54 are arranged one above the other.

It is understood that the present invention is not limited to said preferred spatial arrangement of the components in the sensor housing 46. For example: the circuit board 50 and the battery 54 may also be arranged side by side and/or the sensor housing 46 may be substantially rectangular in the circumferential direction; the sensor housing 46 can have a lid detachably connected to a main body of the sensor housing 46, so that the battery 54 can be replaced easily; the two screw tabs 68 can be aligned in a longitudinal direction of the protective tube 7; a rubber material can be provided between the protective tube 7 and a contact surface of the sensor housing 46; the positioning journal 60 and the bore 62 can be provided laterally on the underside of the sensor housing 46; at least two positioning journals 60 can be provided at locations corresponding to the location of the screw tabs 68, wherein the positioning journals can be designed to cooperate with the two screw tabs 68 by, for example, providing a female thread for the male thread of a screw; the position journal(s) 60 can have a shoe configured to butt against an inner surface of the protective tube and to install the position journal(s) 60 in the bore 62 with positive locking.

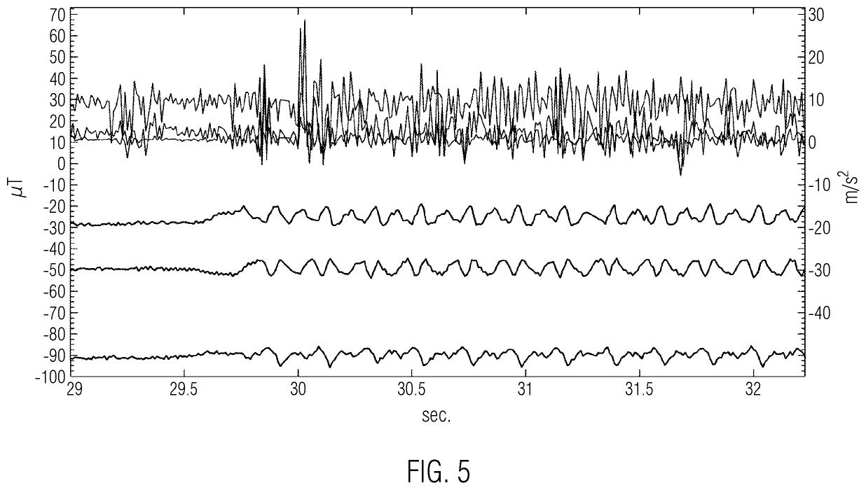

FIG. 5 shows an illustration with several graphs indicating an acceleration (in m/s²) and a magnetic field strength (in μT) measured by the measuring device over time (in s) on an agricultural joint shaft in the state of a working machine driven by the joint shaft. The processor uses the extremes of the graphs to evaluate the measurement data.

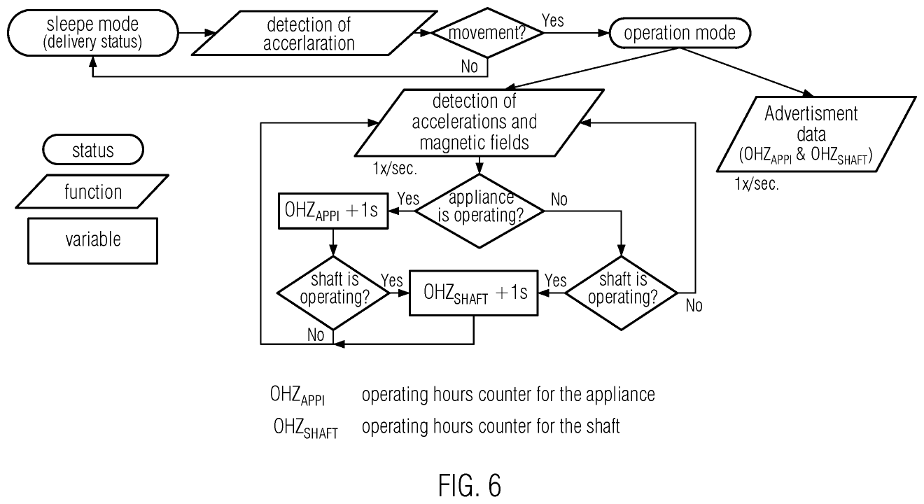

FIG. 6 illustrates in a diagram the process flow for detecting operation of an agricultural joint shaft and an appliance driven by the joint shaft. For simplicity, the agricultural joint shaft is referred to as “shaft” and the working machine as “application” in the diagram. The measuring device is delivered in sleep mode. If an acceleration exceeding a threshold value is registered by the acceleration sensor in sleep mode, the measuring device switches to operating mode.

In the operating mode, at least the acceleration sensor and the magnetic field sensor are in the activated state and the processor evaluates the measurement signals of the sensors continuously, for example in a time increment of one second. According to the evaluation whether the shaft or the application are in operation, an operating hours counter for the application and an operating hours counter for the shaft are incremented. The counter readings can be sent simultaneously (see “Advertisement data”) or with a time delay to a receiver, which can be a mobile terminal and/or provided in the towing vehicle, for example.

### LIST OF REFERENCE SIGNS

1 agricultural joint shaft
2 first joint
3 second joint
4 shaft body
5 inner tube
6 outer tube
7 protective tube
8, 9 protective funnel
10 outer protective tube
11 inner protective tube
12 chain
13, 14 journal cross
15, 16 fork
44 measuring device
46 sensor housing
48 magnetic field sensor
50 circuit board
52 processor
54 battery
58 projection
60 positioning journal
62 bore
63 acceleration sensor
64 inner surface
66 outer surface
68 screw tab
70 lateral straight surface section of the inner surface
72 curved surface section of the inner surface
74 lateral straight surface section of the inner surface
76 straight central surface section of the inner surface

1. A measuring device with a magnetic field sensor for detecting at least one operating parameter of an agricultural joint shaft for torque transmission between a power take-off shaft of a towing vehicle and a transmission of an agricultural appliance, which comprises at least one journal cross, to the opposing journals of which a shaft body is connected, and a protective tube rotatably accommodating the shaft body therein, wherein the magnetic field sensor is adapted to measure a magnetic field emanating from the bare shaft body of the joint shaft.

2. The measuring device according to claim 1, further comprising a closed sensor housing, which accommodates the magnetic field sensor and an energy source for the magnetic field sensor therein and is adapted for non-rotatable attachment to an outer or an inner side of the protective tube.

3. The measuring device according to claim 2, wherein the sensor housing has a concave inner surface which can be applied to the protective tube and is formed from at least one of curved surface sections or straight surface sections.

4. The measuring device of claim 3, wherein the sensor housing has, opposite the inner surface, a convex outer surface formed of at least one of curved surface sections or straight surface sections.

5. The measuring device according to claim 2, wherein the sensor housing is provided with a positioning journal on a side forming a contact surface for contact with the protective tube, which positioning journal engages in a bore of the protective tube.

6. The measuring device according to claim 2, further comprising at least one of an acceleration sensor or a temperature sensor provided in the sensor housing.

7. The measuring device according to claim 2, further comprising a processor provided in the sensor housing, which processes a sensor signal of at least one sensor to determine at least one operating parameter of the joint shaft.

8. The measuring device according to claim 7, further comprising an operating hours counter for the joint shaft, which is incremented as a function of the at least one operating parameter.

9. The measuring device according to claim 7, wherein the processor evaluates the sensor signal for detecting a movement of a working machine connectable to the joint shaft and increments an operating hours counter for the working machine as a function of a duration of the detected movement.

10. The measuring device according to claim 7, further comprising a transmitting device provided in the sensor housing and connected data-wise to the processor, which transmits at least one of the determined operating parameter(s) and a counter reading of the operating hours counter wirelessly to a receiver adapted for data processing.

11. The measuring device according to claim 8, further comprising means for outputting at least one of a warning signal and a maintenance signal triggered by reaching a predetermined counter reading of the operating hours counter.

12. The measuring device according to claim 7, further comprising a stand-by mode and an operating mode implemented as control logic on the processor, wherein the processor is arranged to switch from the stand-by mode to the operating mode in response to a sensor signal from one of the sensors.

13. An agricultural joint shaft for torque transmission between a power take-off shaft of a towing vehicle and a transmission of an agricultural appliance, with at least one journal cross, to the opposite journals of which a shaft body is connected, with a protective tube rotatably accommodating the shaft body, and with a measuring device comprising a magnetic field sensor for detecting at least one of an operation and an operating parameter of the agricultural joint shaft, wherein the measuring device is fastened in a rotationally fixed manner to the protective tube, and wherein the magnetic field sensor is adapted to measure a magnetic field change of a magnetic field emanating from the bare shaft body of the joint shaft.

14. The agricultural joint shaft according to claim 13, wherein the measuring device comprises a closed sensor housing, which accommodates the magnetic field sensor and an energy source for the magnetic field sensor therein, the sensor housing being dimensioned such that a protective funnel for the journal cross can be slipped over the sensor housing onto the protective tube.

15. The agricultural joint shaft according to claim 13, wherein the measuring device is configured to detect rotation of the protective tube.

16. The agricultural joint shaft according to claim 15, wherein the measuring device is configured to initiate at least one of a warning signal or an alarm in response to the detection of a rotation of the protective tube.

17. Method for detecting an operation of a work machine coupled to a commercial vehicle and connected to the commercial vehicle by an agricultural joint shaft for torque transmission between a power take-off shaft of the commercial vehicle and a transmission of the work machine, the agricultural joint shaft having at least one journal cross, to the opposing journals of which a shaft body is connected, and a protective tube rotatably accommodating the shaft body therein, wherein operation of the work machine is detected by evaluating a sensor signal of a magnetic field sensor measuring a magnetic field change of a magnetic field emanating from the bare shaft body of the agricultural joint shaft.
